(19) United States
(12) Patent Application Publication
(10) Pub. No.: US 2013/0219262 A1
(43) Pub. Date: Aug. 22, 2013

(54) SYSTEM AND METHOD FOR INFORMATION AGGREGATION

(71) Applicant: Third Iron, LLC, (US)

(72) Inventors: Karl Becker, Marion, IA (US); John Seguin, Lawrence, KS (US); Kendall Bartsch, Hugo, MN (US)

(73) Assignee: THIRD IRON, LLC, St. Paul, MN (US)

(21) Appl. No.: 13/768,525

(22) Filed: Feb. 15, 2013

Related U.S. Application Data
(60) Provisional application No. 61/600,442, filed on Feb. 17, 2012.

(51) Int. Cl. G06F 17/22

(52) U.S. Cl. CPC G06F 17/2247
USPC 715/234

(57) ABSTRACT

A system for electronically reconstituting an issue of an electronic publication to simulate its paper analog. The system includes an application web server programmed to collect metadata related to a plurality of electronic publication. A user's viewing device is programmed to receive table of contents metadata for a plurality of the electronic publication, a plurality of issues of the electronic publication, and a plurality of articles for the issues. An input device on the user's viewing device is provided to identify from the table of contents metadata a selected electronic publication, a selected issue from the selected publication, and a selected article from the selected issue. A digital object identifier resolver is programmed to identify a URL for the selected article. A display device on the user's viewing device displays a full text version of the selected article.

### REFERENCE TO RELATED APPLICATIONS

The present application claims the benefit of U.S. Provisional Application No. 61/600,442, entitled System and Method for Information Aggregation, filed Feb. 17, 2012, the entire disclosure of which is hereby incorporated by reference.

### TECHNICAL FIELD

The present disclosure relates to a method and system for aggregating electronic content. The user is presented with the table of contents of the available publications and particular issues of a publication that permits browsing of the available articles. The table of contents and the articles are displayed in a format similar to their paper analog.

### BACKGROUND

Libraries maintain access to hundreds or even thousands of electronic publications. Each issue of a publication can contain dozens of discrete articles. While the electronic revolution in the serials world was initially occurring in parallel to print access, this publishing model quickly turned into predominantly electronic distribution—particularly in the academic market due to the advantages of the lower cost of distribution and easier access to material by library users who could now access this material from anywhere given proper authentication.

These electronic publications are held in content databases that are based on a search paradigm. In particular, each article contained in a particular issue of a publication is typically stored as a discrete file. If a user wants to browse the current issue of a particular publication for articles of interest, the current search paradigm does not easily support this type of activity.

To find a specific article within the database, a user is required to enter a complex search query to retrieve a specific article for a specific publication. This complexity is multiplied by the fact that a typical library may provide access to electronic publications through dozens of different databases, each with their own unique platform design and search methodology

Advanced search engines can provide the user with a list of publications, the relevant chapters in which the search terms are occurring, information about the publisher, the author of the work, the International Standard Serial Number (ISSN), the cover image of the publication, etc. The search can further generate a search index from the relevant database, wherein both the data and the metadata are searched correlating the query to at least one article contained in the database.

These search results typically direct the user to a particular web page and not to the content in which the words occur. Locating the exact document in which these words occur is still a step or two away as the user doing the search now has to locate the “Full Text” button on the abstract page. The location varies from publisher to publisher, potentially presenting an additional point of confusion for the user.

As more and more libraries are opting for electronic-only access to publications, the experience of browsing a library's collection of new issues of particular publications to keep up with the latest research trends is an awkward task requiring setting up alert systems, RSS feeds and other clumsy technologies on multiple platforms, most of which is not widely adopted by users.

### SUMMARY OF THE DISCLOSURE

The present disclosure relates to a method and system for aggregating electronic content that substitutes a browse paradigm for the conventional search paradigm.

The present system combines individual articles from a database to create complete issue of a publication and arranges the articles in an intuitive newsstand, then delivers the articles to users in an easy to use format optimized for electronic viewing. The result is an intuitive way for users to browse publications by subject, discover new titles, and easily read articles. In the preferred embodiment, the content presentation is optimized for tablet computers.

The present system and method presents the user with the table of contents for issues of a publication. The user can browse the table of contents for articles of interest and then view a particular article. The table of contents and the articles are displayed in a format similar to their paper analog. By making content available in an easy to view, browsable format, libraries are able to pull away the layers of technology between the user and content.

Users can arrange favorite publications in a convenient personalized bookshelf, allowing each user to quickly and easily access desired content. Content is available 24 hours a day anywhere in the world via authentication protocols. The present system and method can also deliver the content on a pull or push basis. For example, new content since the user's last login can be pushed to the user.

One embodiment of the present disclosure is directed to a method of electronically reconstituting an issue of an electronic publication to simulate its paper analog. Metadata is collected in an application web server related to a plurality of electronic publication. Table of contents metadata for a plurality of the electronic publication is transmitted to a user's viewing device. The user identifies a selected electronic publication from the table of contents metadata. Table of contents metadata for a plurality of issues for the selected electronic publication is then transmitted to the user's viewing device. The user identifies a selected issue from the table of contents metadata for the selected publication. Table of contents metadata for the selected issue is then transmitted to the user's viewing device. The user identifies a selected article from the table of contents metadata for the selected issue. A digital object identifier code corresponding to a selected article is transmitted to a digital object identifier resolver. A URL for the selected article is received in the user's viewing device. The URL for the selected article is transmitted to a location where the selected article is hosted. A direct access link to a publisher website is transmitted requesting delivery of the full text of the selected article. A full text version of the selected article is displayed on the user's viewing device.

The metadata for the electronic publications is preferably reconciled with library holdings data for each of a plurality of libraries. The user typically selects a library and the metadata transmitted to the user's viewing device is based on library holdings data for the selected library.

The user has the option to select a subset of the available electronic publications to create a user-specific library. The user display device then displays only the user-specific library.

In one embodiment, the digital object identifier code corresponding to the selected article is transmitted to a proxy server to verifying access rights for the user. In another embodiment, the proxy server evaluates the IP address of the user's viewing device and determines if the IP address is within a designated IP range before transmitting the digital object identifier code corresponding to the selective article to the digital object identifier resolver. If the IP address of the user's viewing device is not within a designated IP range the proxy server verifies authentication information for the user.

In another embodiment, the step of transmitting from the viewing device the URL for the selected article to a location where the selected article is hosted includes downloading a webpage for the URL to the user's viewing device and converting the URL in an URL extractor to a direct link to a full text format for the selected article. If the conversion fails, a web view of the selected article is displayed on the user's viewing device.

The present disclosure is also directed to a system for electronically reconstituting an issue of an electronic publication to simulate its paper analog. The system includes an application web server programmed to collect metadata related to a plurality of electronic publication. A user's viewing device is programmed to receive table of contents metadata for a plurality of the electronic publication, a plurality of issues of the electronic publication, and a plurality of articles for the issues. An input device on the user's viewing device permits the user to identify from the table of contents metadata a selected electronic publication, a selected issue from the selected publication, and a selected article from the selected issue. A digital object identifier resolver identifies a URL for the selected article. A display device on the user's viewing device displays a full text version of the selected article.

### BRIEF DESCRIPTION OF THE DRAWINGS

FIG. 1 is a schematic block diagram of a system for reconstituting electronic articles contained in multiple electronic databases into whole issues of publications viewable on a reading device in accordance with an embodiment of the present disclosure.

FIG. 2 is a schematic block diagram of a digital aggregation system in accordance with an embodiment of the present disclosure.

FIGS. 3A-3D illustrate an example of the present digital aggregation system in accordance with an embodiment of the present disclosure.

FIGS. 4A and 4B are flow charts of a method for reconstituting an issue of an electronic publication in accordance with an embodiment of the present disclosure.

### DETAILED DESCRIPTION

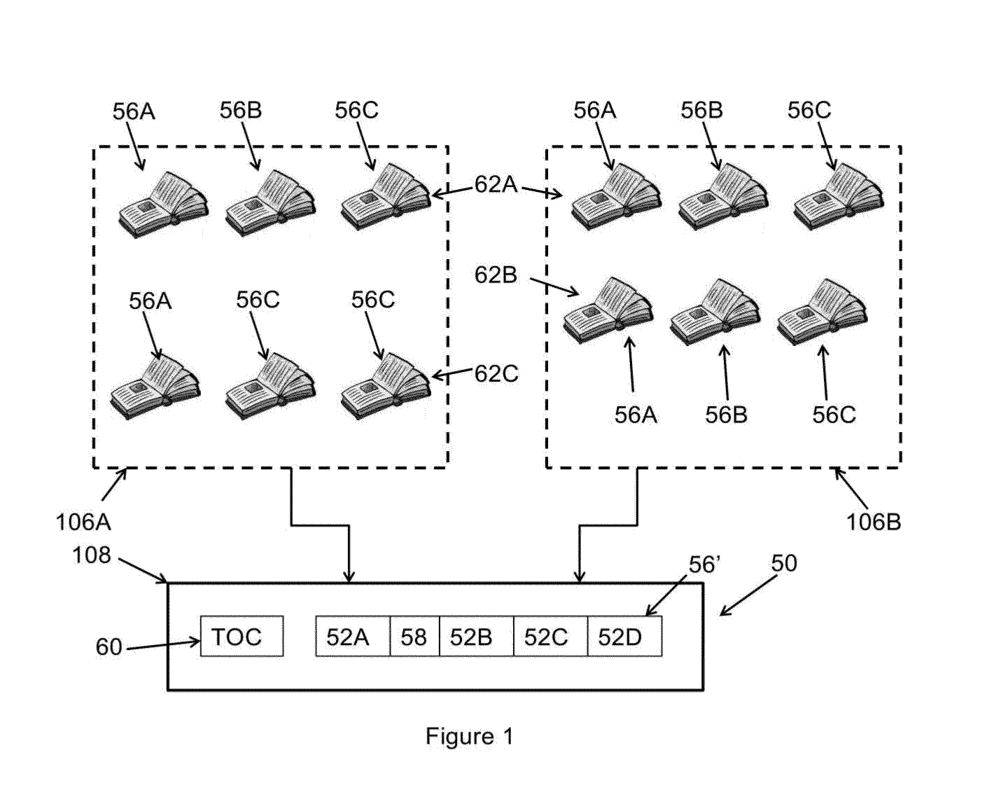

FIG. 1 illustrates a digital aggregation system 50 for reconstituting a particular issue 56A, 56B, 56C (“56”) of a particular publication 62A, 62B, 62C (“62”). In the illustrated embodiment, the publications 62 reside in one or more databases 106A, 106B (“106”). The publication 62 is typically a book, manual, newspaper, magazine, periodical, catalog, journal, and the like.

The system 50 pulls a particular publication 60 from one or more of the databases 106 and generates table of contents data 60 for the publication 62 from the database 106 from which the publication 62 was pulled. For example, the system 50 pulls the publication 62B from database 106B and generates the table of contents data 60 for the publication 62B from the database 106B.

The table of contents data 60 for the available publications 62 is displayed on a display device 108. The viewing device 108 is typically a computer, a tablet, a smart phone, a web-enabled television, or similar device configured to present the reconstituted articles 52′ in a format similar to a paper analog of the publication 62.

After the user selects a particular issue 56 from the selected publication 62, the system 50 then generates table of contents data 60 showing the articles 52A, 52B, 52C, 52D (“52”) available in the selected issue 56. The process of generating the table of contents data 60 for the reconstituted issue 56′ is typically performed from a single database 106. The user views a table of contents data 60 and selects one of the articles 52. The table of contents 60 provides links directly the applicable article 52. The reconstituted issue 56′ displays the articles 52 organized in the same order and with the same look and feel as the original issue 56 to permit serial browsing, either forward or backwards, as if flipping pages of the original issue 56. As used in this application, “reconstituted issue” refers to an electronic collection and arrangement of discrete data files to create an electronic simulation of an original issue of a publication.

The present digital aggregation system 50 is particularly useful in connection with serialized publications 60. The user selects a particular issue 56 of a publication (e.g., December 2012 issue of IEEE Spectrum Magazine) and can then review the table of contents 60 for that reconstituted issue 56′, and can read any article 52′ in that issue 56′ selected from the table of contents 60.

In one embodiment, the reconstituted issue 56′ is augmented to include additional content 58, such as for example, audio/visual content, updates, and the like, that was not available in the original issue 56.

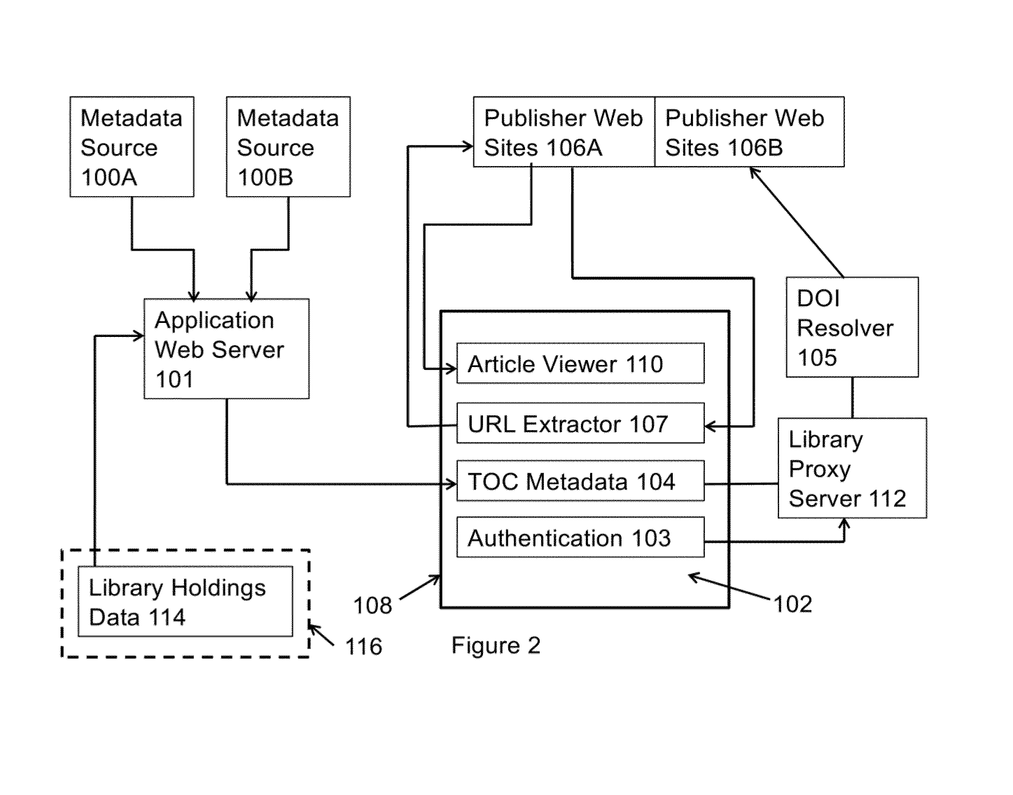

As illustrated in FIG. 2, software application 102 resides on the user's viewing device 108. The software application 102 includes a number of key modules for the present digital aggregation system 50: authentication module 103, table of contents (TOC) metadata 104, Universal Resource Locator (URL) extractor 107, and article viewer module 110, each of which are discussed in detail below.

In operation, application web server 101 harvests metadata provided by one or more third party metadata sources 100A, 100B (“100”) and stores the metadata in a database. The application web server 101 formats this metadata into a table of contents metadata 104 that can be quickly delivered to a user, as discussed below.

Since most libraries 116 contain only a subset of the total available electronic publications 60, the application web server 101 reconciles the metadata with the publications 60 available from the library holdings data 114 for each library 116. As a result, users associated with a particular library 116 will only receive metadata for publications 60 actually available in the library holdings data 114. This structure avoids the problem of a user requesting access to a publication 62 that is not available from the library 116. As used herein, “library” refers generically to any entity that maintains subscriptions for a plurality of publications, such as for example, a public library, corporation, educational institution, governmental entity, and the like.

The metadata is analogous to data that is traditionally found in card catalogs of libraries, which describes the content and context of articles 52 and issues 56 of publications 60. The information is typically presented in a format that contains metadata for each document including the title, author(s), publisher, date of publication, volume, issue and page numbers, and the assigned Digital Object Identifier (DOI) code and/or a direct access URL.

A DOI code is a unique identifier assigned by one of a number of different registration agencies working with the International DOI Foundation (www.doi.org). Metadata about an article 52 is stored in association with the DOI code and typically includes an electronic location or address, such as a URL, where the article 52 can be found.

The DOI for an article 52 is permanent, whereas the article's location and other metadata may change. Referring to an online article 52 by its DOI provides a more stable linking than simply referring to it by its URL, because if the URL changes the publisher need only update the metadata for the DOI to link to the new URL. As long as publishers register changes with the DOI Foundation, the DOI will continue to redirect and “point” to the correct URL to retrieve that article 52 regardless where it resides.

The user activates the software application 102 on the user's viewing device 108. The user then selects the appropriate institution/library 116 that he wants to access. The application web server 101 only delivers metadata to the users viewing device 108 corresponding to the publications 60 held in the library holdings data 114.

The table of contents metadata 104 is loaded locally in the user's viewing device 108, which is very quickly retrieved for a fast and satisfying user experience versus constant calls to a web server. Since the table of contents metadata 104 may change on a daily basis, upon launch the software application 102 quickly checks with the application web server 101 for updates.

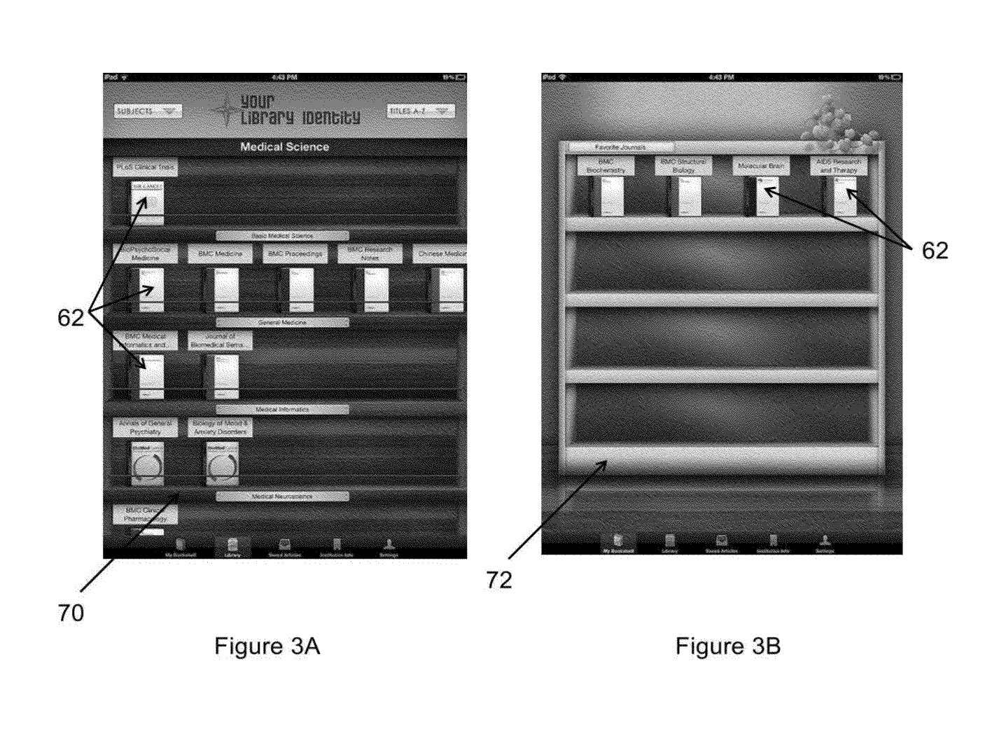

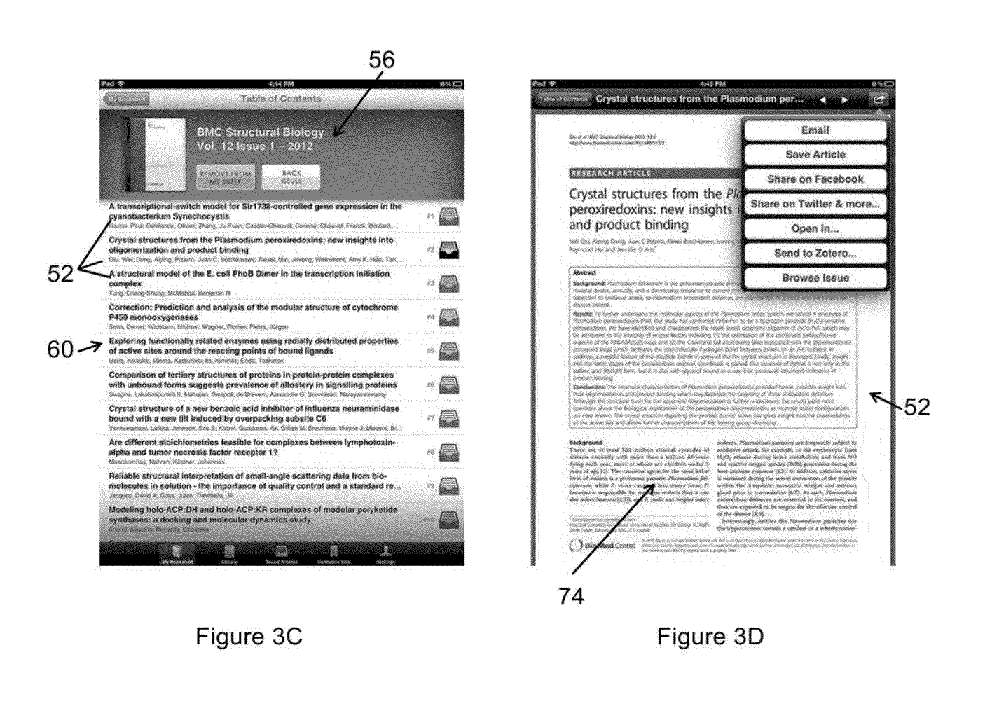

The publications 60 are preferably organized onto virtual graphical bookshelves to make this browsing experience similar to a traditional print library experience (see e.g., FIG. 3A). The user first selects a publication 62. After the user selects a particular publication 62, the table of contents metadata 104 is presented to the user as a series of table of contents for each issue 56, permitting the user to browse the available issues 56.

The user then selects a particular issue 56 from the selected publication 62 and a particular article 52 from the selected issue 56. In the preferred embodiment, only the user's favorite publications 60 are presented on the viewing device 108 in a convenient personalized bookshelf format, allowing each user to quickly and easily access desired content. In another embodiment, the software 102 is configured to pull new or updated issues 56 of selected publications 60 since the user's last login to the system 50.

Once an article 52 of interest is found in the tables of contents 104, the digital object identifier associated with the selected article is sent to a library proxy server 112 to verify the user's access rights. The proxy server 112 first checks to determine the IP of the requesting device 108 and if it is within a designed IP range, the request is simply passed through without credentialing. If it is not within this range, the proxy server 112 then presents to the application 102 a request to authenticate which is administered by the authentication module 103, which contains the authentication information stored previously by the user. The present authentications module 103 is interoperable with a variety of commercial authentication systems, such as for example, EZproxy, Shibboleth, Bar code identification, and Virtual Private Networks.

If the user is within this IP range and is automatically detected or if the user can provide sufficient access rights via the software application 102, the DOI is either sent to a DOI Resolver to determine the URL for the selected article, or if available, a direct link to the URL of the article is used. There are numerous DOI resolvers maintained by the International DOI Foundation, which will translate the DOI into a URL that will link to a web page where the article 52 is hosted.

The user is not, however, presented the web page associated with the URL. Instead, this web page is downloaded in the background from the publisher website 106 to the software application 102. URL extractor module 107 identifies a direct link to a full text view of the article 52 whether that is a link to a Portable Document Format (PDF) article, text, image, or the like. This link is then used to re-engage the publisher website 106 and download the reconstituted article 52′ to the article viewer module 110 on the viewing device 108.

If URL extractor 107 fails to identify a usable direct link (e.g., due to an unsupported file format such as a movie or audio file is present) the application displays a web view within the software application 102 so as to provide access to the user's requested content.

The article view module 110 allows the user to flip through pages of the reconstituted article 52′, save it for future reading, post a link to it via email or social network and other export options. The user may also move serially (backwards and forward) between articles 52′ within the reconstituted issue 56′ without going back to the table of contents module 104.

FIGS. 3A-3D provide an example of the present digital aggregation system 50 in operation in accordance with an embodiment of the present disclosure.

FIG. 3A illustrates the publications 60 available to a particular user based on the user's access rights. The publications 60 may be provided by multiple publishers and may require multiple subscriptions.

From the user's perspective, however, all the authorized publications 60 are presented in an easy to use bookshelf format 70. The publications 60 can be organized on the electronic bookshelf 70 in any manner, such as by subject matter, publisher, and the like.

From the publications 60 in the user's library, the user may create a personal library 72 of publications 60 of particular interest to the user. The publications shown in FIG. 3B are a subset of the publications 60 illustrated in FIG. 3A selected by the user. The personal library option permits the user to quickly bypass publications 60 that are not of interest. Once a particular publication 62 is part of the user's personal library 72, the present system 50 optionally sends a push notification to the viewing device 108 when a new issue 56 of the selected publication 62 is available.

FIG. 3C illustrates table of content data 60 for a current issue 56 from one of the publications 60 shown in FIG. 3B. The table of contents 60 is designed to be an electronic analog to a paper copy of the issue 56. This table of contents data 60 is delivered as metadata, reducing transmission time. The user has the option to scroll through the table of contents data 60 until an article 52 of interest is selected.

FIG. 3D illustrates the first page 74 of the article 52 selected from the table of contacts 60 illustrated in FIG. 3C. Again, the article 52 is displayed in a format to simulate the paper analog to the electronic publication.

The present digital aggregation system 50 provides the user the option to email, save, or share the selected article 52. The user can also browse the entire issue 56 sequentially (forward or backwards) as if using a paper analog of the issue 56.

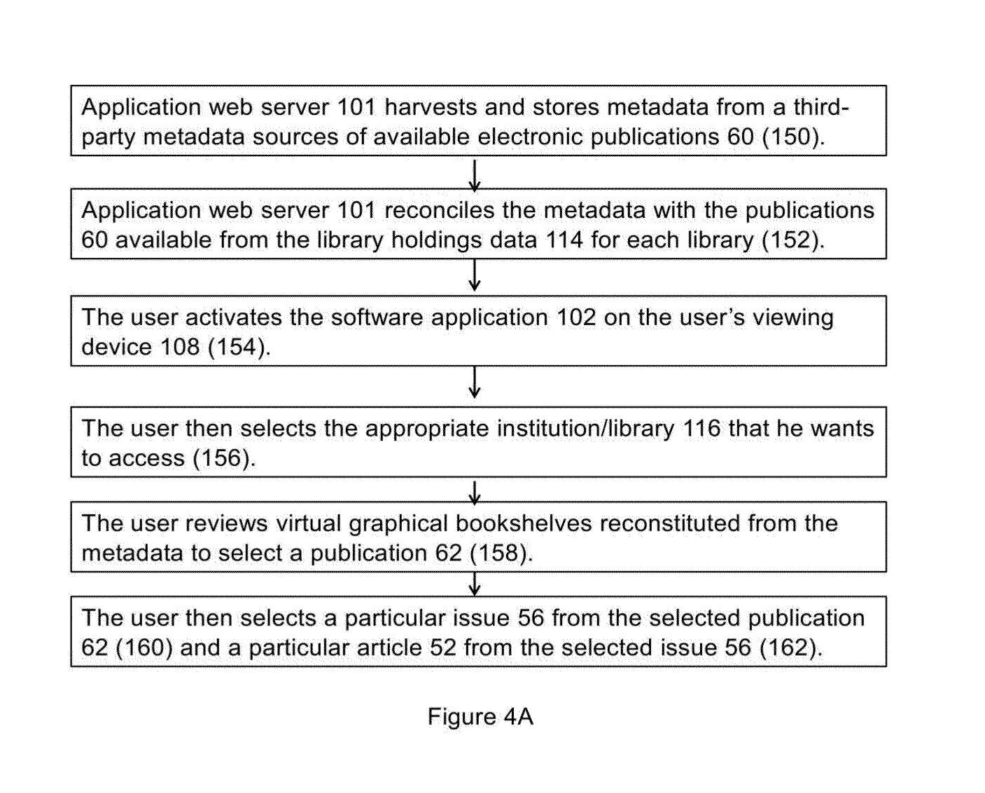

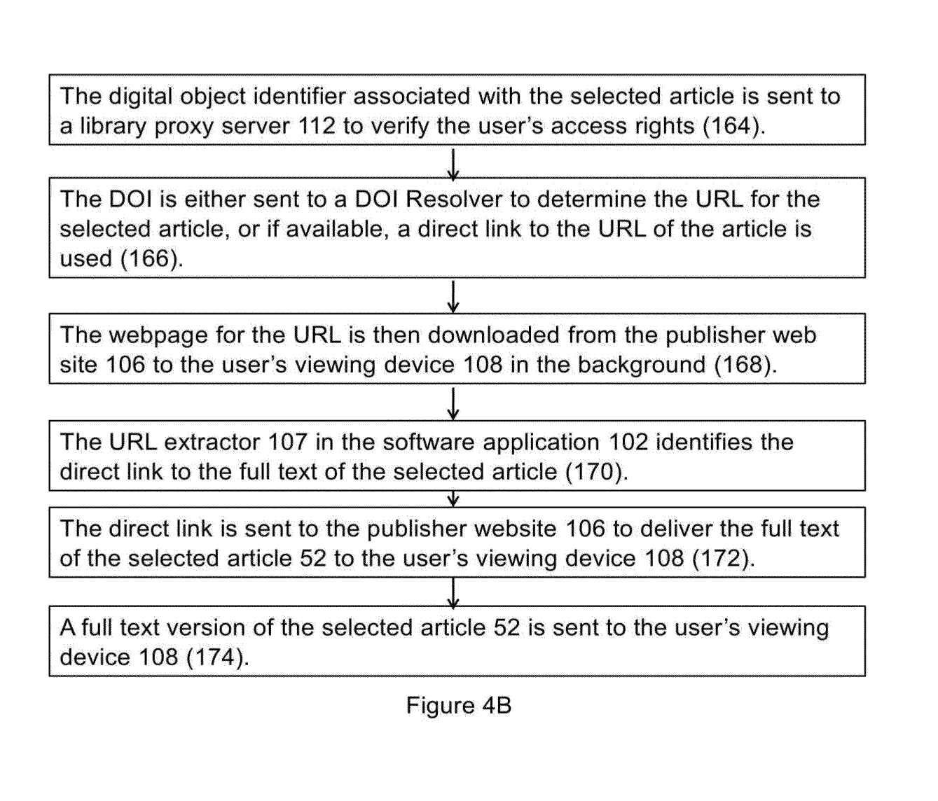

FIGS. 4A and 4B are flow charts of the present digital aggregation system 50 in accordance with an embodiment of the present disclosure. The application web server 101 harvests and stores metadata from a third-party metadata sources of available electronic publications 60 (150). Since most libraries contain only a subset of the total available electronic publications, the application web server 101 reconciles the metadata with the publications 60 available from the library holdings data 114 for each library (152). As a result, users associated with a particular library will only receive metadata for publications 60 actually available in the library holdings data 114.

The user activates the software application 102 on the user's viewing device 108 (154). The user then selects the appropriate institution/library 116 that he wants to access (156). The application web server 101 only delivers metadata to the users viewing device 108 corresponding to the publications 60 held in the library holdings data 114.

The user reviews virtual graphical bookshelves reconstituted from the metadata to select a publication 62 (158). The user then selects a particular issue 56 from the selected publication 62 (160) and a particular article 52 from the selected issue 56 (162).

The digital object identifier associated with the selected article is sent to a library proxy server 112 to verify the user's access rights (164). After authentication, the DOI is either sent to a DOI Resolver to determine the URL for the selected article, or if available, a direct link to the URL of the article is used (166).

The webpage for the URL is then downloaded from the publisher web site 106 to the user's viewing device 108 in the background (168). The URL extractor 107 in the software application 102 identifies the direct link to the full text of the selected article (170). If URL extractor 107 fails to identify a usable direct link (e.g., due to an unsupported file format such as a movie or audio file is present) the application displays a web view within the software application 102 so provide access to the user's requested content is still provided.

The direct link is sent to the publisher website 106 to deliver the full text of the selected article 52 to the user's viewing device 108 (172). A full text version of the selected article 52 is sent to the user's viewing device 108 (174).

Where a range of values is provided, it is understood that each intervening value, to the tenth of the unit of the lower limit unless the context clearly dictates otherwise, between the upper and lower limit of that range and any other stated or intervening value in that stated range is encompassed within this disclosure. The upper and lower limits of these smaller ranges which may independently be included in the smaller ranges is also encompassed within the disclosure, subject to any specifically excluded limit in the stated range. Where the stated range includes one or both of the limits, ranges excluding either both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the various methods and materials are now described. All patents and publications mentioned herein, including those cited in the Background of the application, are hereby incorporated by reference to disclose and described the methods and/or materials in connection with which the publications are cited.

The publications discussed herein are provided solely for their disclosure prior to the filing date of the present application. Nothing herein is to be construed as an admission that the present disclosure is not entitled to antedate such publication by virtue of prior invention. Further, the dates of publication provided may be different from the actual publication dates which may need to be independently confirmed.

Other embodiments are possible. Although the description above contains much specificity, these should not be construed as limiting the scope of the disclosure, but as merely providing illustrations of some of the presently preferred embodiments. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form varying modes disclosed. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

What is claimed is:

1. A method of electronically reconstituting an issue of an electronic publication to simulate its paper analog, the method comprising the steps of:
collecting metadata in an application web server related to a plurality of electronic publication;
transmitting to a user's viewing device table of contents metadata for a plurality of the electronic publication;
identifying from the table of contents metadata a selected electronic publication;
transmitting to a user's viewing device table of contents metadata for a plurality issues associated with the selected electronic publication;
identifying a selected issue from the table of contents metadata for the selected publication;
transmitting to a user's viewing device table of contents metadata for the selected issue;
identifying a selected article from the table of contents metadata for the selected issue;
transmitting a digital object identifier code corresponding to a selected article to a digital object identifier resolver;
receiving at the viewing device a URL for the selected article;
transmitting from the viewing device the URL for the selected article to a location where the selected article is hosted;
transmitting from the viewing device a direct access link to a publisher website requesting delivery of the full text of the selected article; and
displaying a full text version of the selected article on the user's viewing device.

2. The method of claim 1 comprising the step of reconciling the metadata for the electronic publications with library holdings data for each of a plurality of libraries.

3. The method of claim 1 comprising the steps of:
selecting a library at the user's viewing device; and
limiting the metadata transmitted to the user's viewing device based on library holdings data for the selected library.

4. The method of claim 1 comprising the steps of:
verifying the publications available in the library holdings data; and
transmitting to the user's viewing device only table of contents metadata corresponding to the available library holdings data.

5. The method of claim 1 comprising the steps of:
selecting a subset of the available electronic publications to create a user-specific library; and
displaying only the user-specific library on the display device.

6. The method of claim 1 comprising the steps of:
transmitting the digital object identifier code corresponding to the selected article to a proxy server; and
verifying access rights for the user.

7. The method of claim 1 comprising the steps of:
evaluating an IP address of the user's viewing device at a proxy server;
determining that the IP address of the user's viewing device is within a designated IP range; and
transmitting the digital object identifier code corresponding to the selective article to the digital object identifier resolver.

8. The method of claim 1 comprising the steps of:
evaluating an IP address of the user's viewing device at a proxy server;
determining that the IP address of the user's viewing device is not within a designated IP range;
verifying authentication information in the user's viewing device; and
transmitting the digital object identifier code corresponding to the selective article to the digital object identifier resolver.

9. The method of claim 1 wherein the step of transmitting from the viewing device the URL for the selected article to a location where the selected article is hosted comprises the steps of:
downloading a webpage for the URL to the user's viewing device; and
converting the URL in an URL extractor to a direct link to a full text format for the selected article.

10. The method of claim 1 wherein the step of transmitting from the viewing device the URL for the selected article to a location where the selected article is hosted comprises the steps of:
downloading a webpage for the URL to the user's viewing device;
attempting unsuccessfully to convert the URL in an URL extractor to a direct link to a full text format for the selected article; and
displaying a web view of the selected article on the user's viewing device.

11. A system for electronically reconstituting an issue of an electronic publication to simulate its paper analog, the system comprising:
an application web server programmed to collect metadata related to a plurality of electronic publication;
a user's viewing device programmed to receive table of contents metadata for a plurality of the electronic publication, a plurality of issues of the electronic publication, and a plurality of articles for the issues;
an input device on the user's viewing device for identifying from the table of contents metadata a selected electronic publication, a selected issue from the selected publication, and a selected article from the selected issue;
a digital object identifier resolver programmed to identify a URL for the selected article; and
a display device on the user's viewing device to display a full text version of the selected article.

12. The system of claim 11 wherein the application web server is programmed to reconcile the metadata for the electronic publications with library holdings data for each of a plurality of libraries.

13. The system of claim 11 wherein the application web server is programmed to limit the metadata transmitted to the user's viewing device based on library holdings data for the selected library.

14. The system of claim 11 wherein the application web server is programmed to:
verify the publications available in the library holdings data; and
transmit to the user's viewing device only table of contents metadata corresponding to the available library holdings data.

15. The system of claim 11 wherein the user viewing devices is programmed to:
select a subset of the available electronic publications to create a user-specific library; and
display only the user-specific library on the display device.

16. The system of claim 11 comprising a proxy server programmed to verify access rights for the user before transmitting the digital object identifier code corresponding to the selected article to the digital object identifier resolver.

17. The system of claim 11 comprising a proxy server programmed to:
evaluate an IP address of the user's viewing device;
determine that the IP address of the user's viewing device is within a designated IP range; and
transmit the digital object identifier code corresponding to the selective article to the digital object identifier resolver.

18. The system of claim 11 comprising a proxy server programmed to:
evaluate an IP address of the user's viewing device at a proxy server;
determine that the IP address of the user's viewing device is not within a designated IP range;
verify authentication information in the user's viewing device; and
transmit the digital object identifier code corresponding to the selective article to the digital object identifier resolver.

19. The system of claim 11 wherein the user viewing device is programmed to:
downloading a webpage for the URL; and
convert the URL in an URL extractor to a direct link to a full text format for the selected article.

20. The system of claim 11 wherein the user viewing device is programmed to:
downloading a webpage for the URL;
attempt to convert the URL in an URL extractor to a direct link to a full text format for the selected article; and
display a web view of the selected article on the user's viewing device if the attempt to convert the URL to a direct link fails.
